(19) United States
(12) Patent Application Publication
(10) Pub. No.: US 2005/0248465 A1
(43) Pub. Date: Nov. 10, 2005

(54) Water leak alarm and method

(76) Inventor: Fred F. Flaherty, St. Clair Shores, MI (US)

Correspondence Address: Christopher J. Fildes;Fildes & Outland, P.C., Suite 2, 20916 Mack Avenue, Grosse Pointe Woods, MI, 48236, US

(21) Appl. No.: 10/838,422

(22) Filed: May 4, 2004

(51) Int. Cl. G08B 21/00

(52) U.S. Cl. 340/605; 137/15.11

(57) ABSTRACT

A leak alarm includes a liquid flow detector and an electronic alarm circuit having a first timer, a second timer cooperable with and electrically connected to the first timer, and an alarm electrically connected to the second timer. The first timer has a first timer cycle time and the second timer has a second timer cycle time. The first timer cycle time is shorter in time than the second timer cycle time. The liquid flow detector is electrically connected to the electronic alarm circuit. The first timer resets itself to zero when the liquid flow detector senses a flow of liquid, the first timer resets both itself and the second timer to zero when the first timer reaches the first timer cycle time, and the second timer triggers the alarm when the second timer reaches the second timer cycle time.

### TECHNICAL FIELD

This invention relates to leak alarms, and more particularly to leak alarms for detecting intermittent leaks in a faucet or float controlled device such as a toilet or similar.

### BACKGROUND OF THE INVENTION

Conventionally, domestic water leaks are detected primarily by the occupant hearing the leak. For example, an occupant of a residence detects a leaky toilet by hearing the sound of water flowing through valves of the toilet and the pipes leading to the toilet. Manufacturers of toilet filler valves have been designing quieter filler valves, which make the audible detection of leaks more difficult. Further, some household toilets are located in remote areas of a residence where people do not regularly enter. Therefore, no one is present to listen for or hear leaks while the toilet is in non-use.

Domestic water leaks may also be detected by an occupant noticing an unusual increase in water consumption in the household water bill. Yet some users of domestic water, such as apartment tenants, are not directly responsible for paying water bills. These water users therefore will not be made aware of a water leak from a water bill. Further, these users of domestic water may not realize the tremendous amount of water that can be wasted over time from a leaky water line.

The strain on municipal water treatment plants to keep up with the demand for fresh, potable water increases every year, while government funding to expand existing treatment plants decreases. Further, maintaining the supply of fresh water to some areas has become particularly problematic, leading to local or regional bans on certain types of water uses. The pressure to conserve fresh water is felt by both suppliers and users alike, and the cost of fresh water is growing much faster than inflation.

These reasons indicate that there is a strong-felt need for a leak detector and alarm for household water lines. Such an alarm would help prevent household water users from having to pay the high costs of excessive water use as well as to help prevent excessive strain on the fresh water supply.

### SUMMARY OF THE INVENTION

The present invention provides a water leak alarm including a flow detector and an electronic alarm circuit connected to each other by an electrical wire. The water leak alarm detects leaks by timing the flow of water and is able to detect very low flow rates of water flow. This allows for the detection of intermittent leaks in water consuming and water controlling household devices regardless of the source or cause of the leak, for example, a leaky toilet or leaky faucet. Triggering of the alarm circuit may lead to a visual alarm the sounding of an audible alarm or to the transmission of a radio frequency alert. The water leak alarm may be used to detect a leaky toilet by connecting the leak alarm to the water line connection at the toilet filler valve. The water leak alarm may also be used to detect leaks in an entire water system for a single residence by connecting the leak alarm just downstream of the main water shutoff valve.

More specifically, a leak alarm in accordance with the present invention includes a liquid flow detector and an electronic alarm circuit. The electronic alarm circuit includes a first timer, a second timer cooperable with and electrically connected to the first timer, and an alarm electrically connected to the second timer. The first timer has a first timer cycle time and the second timer has a second timer cycle time. The first timer cycle time is shorter in time than the second timer cycle time. The liquid flow detector is electrically connected to the electronic alarm circuit. The first timer resets itself to zero when the liquid flow detector senses a flow of liquid. The first timer resets both itself and the second timer to zero when the first timer reaches the first timer cycle time. The second timer triggers the alarm when the second timer reaches the second timer cycle time. The use of two timers in this method is for detecting intermittent leaks such as those caused by float valves used in some household fixtures such as toilets, sump-pumps, humidifiers, or similar.

In one embodiment, the first timer cycle time may be a time of less than one hour and the second timer cycle time may be a time between 24 and 72 hours. The electronic alarm circuit may include a reset button capable of simultaneously resetting both the first and second timers to zero. The electronic alarm circuit may further include an LED that illuminates when the liquid flow detector senses a flow of liquid. The alarm may be an audible alarm, a radio frequency alert device, and/or a visual alarm. The liquid flow detector may be a mechanical flow detector including a housing, a hydraulic piston having a specific gravity greater than the specific gravity of water and being linearly moveable within the housing, a magnet at one end of the hydraulic piston, a stop within the housing, and a reed switch mountable to the outside of the housing. The liquid flow detector may be electrically connected to the electronic alarm circuit at the reed switch. The liquid flow detector may be capable of detecting low flow rates of one gallon per hour or less.

A method of detecting a leak in a liquid pipeline includes the steps of: providing a liquid flow detector and an electronic alarm circuit having a first timer, a second timer, and an alarm; initially setting both the first timer and the second timer to zero; starting the first timer to count a first timer elapsed time and the second timer to count a second timer elapsed time; monitoring a flow rate in the liquid pipeline with the liquid flow detector; resetting the first timer to zero when the flow rate in the pipeline is greater than or equal to a pipeline minimum flow; after the step of resetting the first timer to zero when the flow rate in the pipeline is greater than or equal to a pipeline minimum flow, starting the first timer to count the first timer elapsed time; resetting both the first timer and the second timer to zero when the flow rate in the pipeline is below the pipeline minimum flow for a first timer elapsed time equaling a preset first timer cycle time; after the step of resetting both the first timer and the second timer to zero when the flow rate in the pipeline is below the pipeline minimum flow for a first timer elapsed time equaling a preset first timer cycle time, starting the first timer to count the first timer elapsed time and the second timer to count the second timer elapsed time; and triggering the alarm when the second timer elapsed time equals a preset second timer cycle time indicating that the flow rate in the pipeline is at or above the pipeline minimum flow for each first cycle time during the second timer cycle time.

Optionally, the pipeline minimum flow may be approximately zero gallons per hour. The first timer cycle time may be a time less than one hour. The second timer cycle time may be a time between 24 and 72 hours.

These and other features and advantages of the invention will be more fully understood from the following detailed description of the invention taken together with the accompanying drawings.

### BRIEF DESCRIPTION OF THE DRAWINGS

In the drawings:

FIG. 1 is an environmental view of a leak alarm in accordance with the present invention connected to a water line connection at a toilet filler valve;

FIG. 2 is an electrical block diagram of an electronic alarm circuit of a leak alarm in accordance with the present invention;

FIG. 3A is a cutaway elevational view of an embodiment of a liquid flow detector of the leak alarm of FIG. 1;

FIG. 3B is a sectional view taken along line B-B in FIG. 3A;

FIG. 3C is a sectional view taken along line C-C in FIG. 3A;

FIG. 3D is a cutaway elevational view of the embodiment of FIG. 3A illustrating flow of liquid through the liquid flow detector;

FIG. 4 is an environmental view of a leak alarm in accordance with the present invention connected just downstream of a household main water shutoff valve;

FIG. 5A is a cutaway elevational view of an embodiment of a liquid flow detector of the leak alarm of FIG. 4;

FIG. 5B illustrates low flow of liquid through the liquid flow detector of FIG. 5A;

FIG. 5C illustrates regular flow of liquid through the liquid flow detector of FIG. 5A; and

FIG. 6 is a flowchart diagram of the operations performed to detect a leak according to the present invention.

### DETAILED DESCRIPTION OF THE INVENTION

Referring now to the drawings in detail, numeral 10 generally indicates a leak alarm in accordance with the present invention useful for detecting intermittent leaks in a household water supply system caused by a toilet leak or other float controlled devices or water controlling devices such as a faucet or similar. The leak alarm 10 detects leaks by timing the flow of water in a water line, allowing for the detection of leaks in a household water line regardless of the source or cause of the leak.

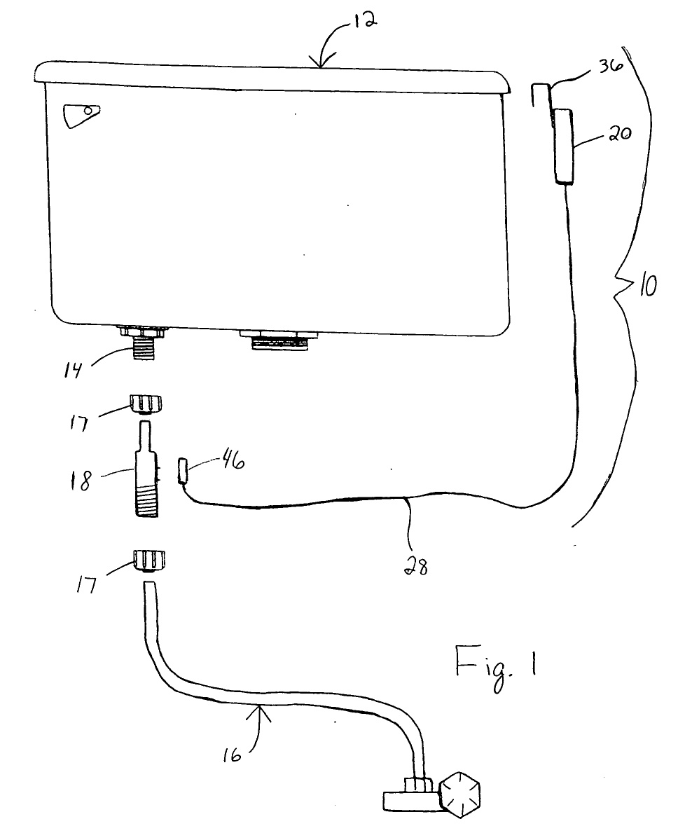

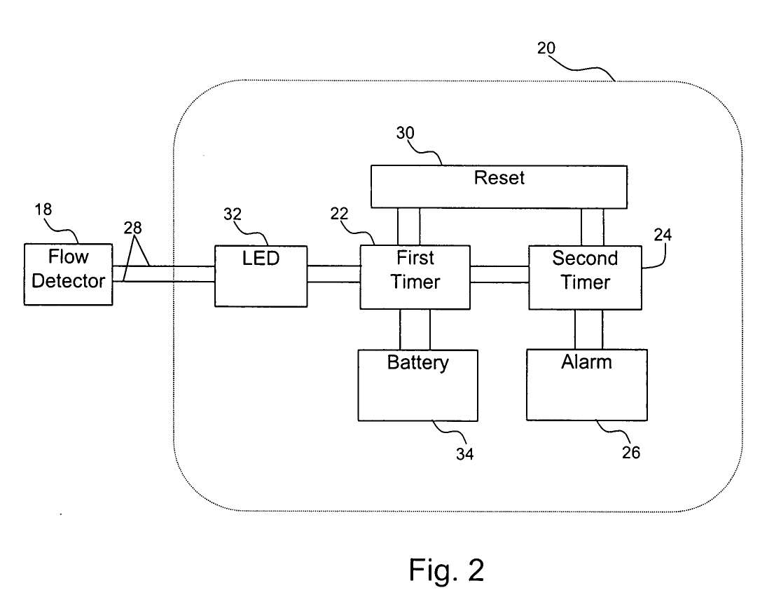

FIG. 1 illustrates an embodiment of a leak alarm 10 in accordance with the present invention being used to detect a water leak in a toilet 12. In this embodiment, the leak alarm 10 is connected to a water line connection 14 at a toilet filler valve (not shown) and connected to a water source 16. This connection may be achieved with the aid of coupling nuts 17. The leak alarm 10 includes a liquid flow detector 18 and an electronic alarm circuit 20. As shown in FIG. 2, the electronic alarm circuit 20 includes a first timer 22, a second timer 24 cooperable with and electrically connected to the first timer 22, and an alarm 26 electrically connected to the second timer 24. The first timer 22 may be capable of controlling the second timer 24 and the second timer 24 may be capable of triggering the alarm 26. The first timer 22 has a first timer cycle time and the second timer 24 has a second timer cycle time. The first timer cycle time is shorter in time than the second timer cycle time. The liquid flow detector 18 is electrically connected to the electronic alarm circuit 20 by an electric wire 28. The first timer 22 resets itself to zero when the liquid flow detector 18 senses a flow of liquid. The first timer 22 resets both itself and the second timer 24 to zero when the first timer 22 reaches the first timer cycle time. The second timer 24 triggers the alarm 26 when the second timer 24 reaches the second timer cycle time.

The first timer cycle time may be a time less than one hour and the second timer cycle time may be a time between 24 and 72 hours. The first timer cycle time and the second timer cycle time may be adjusted depending upon the application of the leak alarm 10. For example, the first timer cycle time may be 15 minutes and the second timer cycle time may be 24 hours. It is only necessary that the first timer cycle time be shorter than the second timer cycle time. For most applications, the first timer cycle time should be of the magnitude of an hour or fractions of an hour while the second timer cycle time should be of the magnitude of a day or days.

The electronic alarm circuit 20 may include a reset button 30 capable of simultaneously resetting both the first timer 22 and the second timer 24 to zero. The reset button 30 may be designed such that it is only operable when the alarm 26 has been triggered. This would prevent inadvertent resetting of the leak alarm 10 prior to a potential leak being detected. Further, the reset button 30 may be designed such that it has a delay function that delays the leak alarm 10 from starting to detect leaks for a period of time, such as 72 hours, after the reset button has been depressed in response a triggered alarm 26. This allows a period of time for plumbing repairs to be made. The electronic alarm circuit 20 may further include an LED 32 that illuminates when the liquid flow detector 18 senses a flow of liquid. The alarm 26 may be an audible alarm, a radio frequency alert device, a visual alarm, or any combination of these three. An audible alarm, such as a buzzer or beeper, may directly alert a home occupant that a leak has been detected. A visual alarm, such as a light bulb or LED, similarly provides a direct alert for a home occupant that a leak has been detected. A radio frequency alert device allows the detection of a leak to be sent to a location external to a residence such as a local water distributor. A radio frequency alert device also allows for the detection of a leak to be sent from a remote area of a residence to a non-remote area where a home occupant may readily observe the alert.

The electronic alarm circuit 20 may be powered by with a battery power source 34 such as a 9 volt battery. Similar to a smoke detector, the electronic alarm circuit 20 may be wired so that the alarm 26 sounds when the power source 34 is low. Alternatively, the electronic alarm circuit 20 may include a separate low battery alert indicator. The electronic alarm circuit 20 may also include an external hanger member 36 for mounting the electronic alarm circuit 20 on an object, for example, a toilet 12.

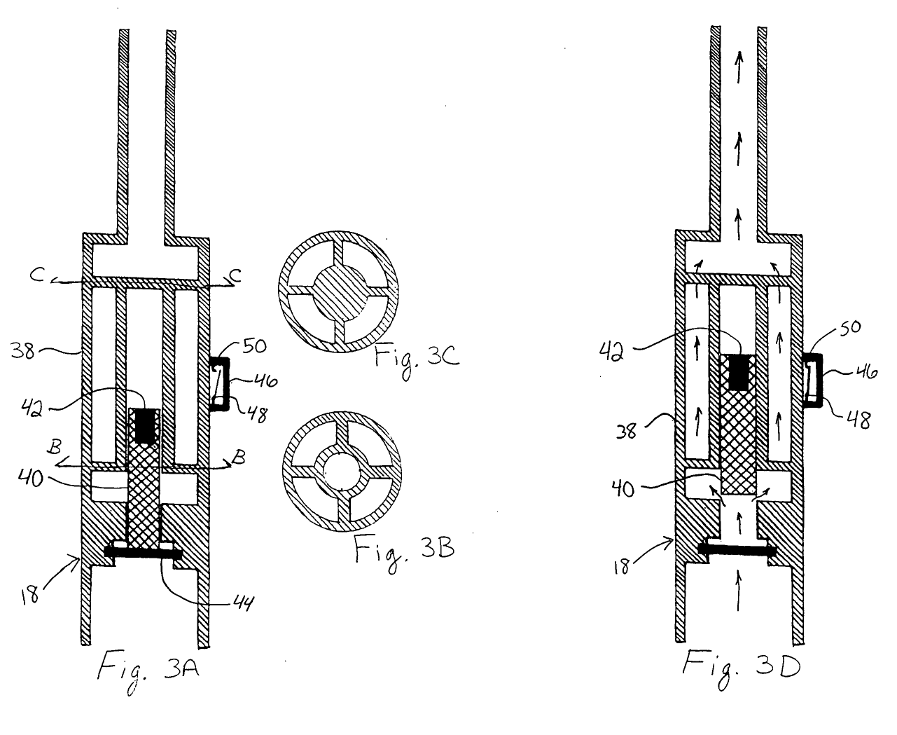

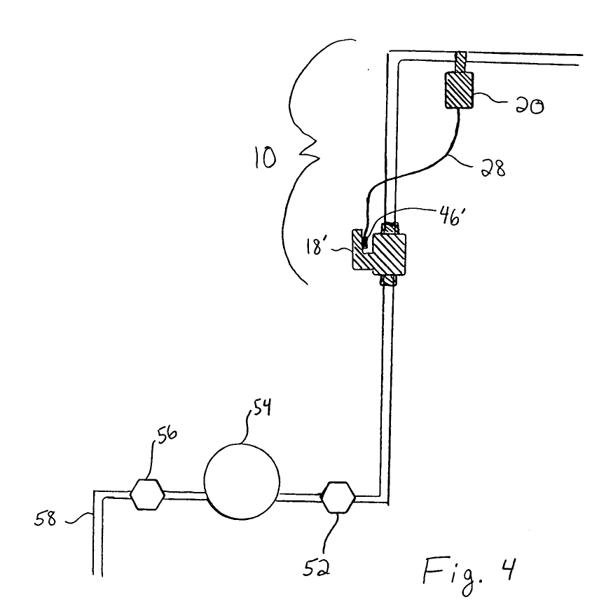

As shown in FIGS. 3A through 3D, the liquid flow detector 18 may be an electro-mechanical flow detector including a housing 38, a hydraulic piston 40 having a specific gravity greater than the specific gravity of water and being linearly moveable within the housing 38, a magnet 42 at one end of the hydraulic piston 40, a stop 44 within the housing 38, and a reed switch 46 mountable to the outside of the housing 38. The liquid flow detector 18 may be electrically connected to the electronic alarm circuit 20 at the reed switch 46 as shown in FIG. 1. The functioning of this embodiment of the liquid flow detector 18 is illustrated by FIGS. 3A and 3D. In FIG. 3A, the flow detector 18 is oriented vertically and there is no water flowing through the flow detector. The piston 40, having a specific gravity greater than water, rests against the stop 44, in this case a brass pin. The magnet 42 is thereby positioned below a pivot point 48 of the reed switch 46, and the reed switch 46 rests a distance from an electric contact 50. In FIG. 3D, liquid such as water, represented by arrows, is flowing through the flow detector 18. The flow of water pushes the piston 40 linearly upwards. The magnet 42 is thereby positioned above the pivot point 48 of the reed switch 46, and the reed switch, itself magnetic, is drawn against the electric contact 50. When the reed switch 46 contacts the electric contact 50, an electric circuit is closed, thereby providing an indication that there is flow through the flow detector 18. The liquid flow detector 18 may be capable of detecting low flow rates of one gallon per hour or less. Alternatively, the liquid flow detector 18 may be an electronic flow detector or any other construction of flow detector capable of detecting flow rates as least as low as one to two gallons per hour.

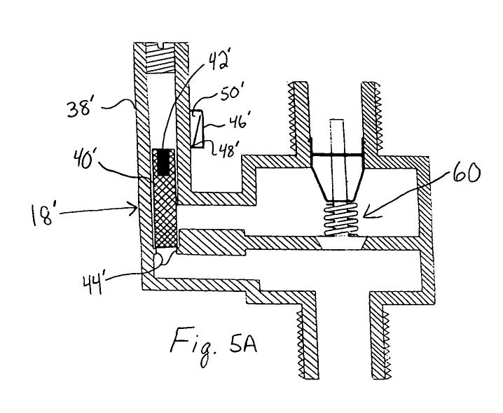

FIG. 4 illustrates another embodiment of a leak alarm 10 in accordance with the present invention being used to detect a water leak in an entire water system for a household residence. In this embodiment, the leak alarm 10 is connected just downstream of a household main water shutoff valve 52. The shutoff valve 52 may be located just downstream of a household water meter 54. A second shutoff valve 56 may be located upstream of the water meter 54. A fresh water supply 58 from a local community water source supplies water through the water meter 54 into the household water system.

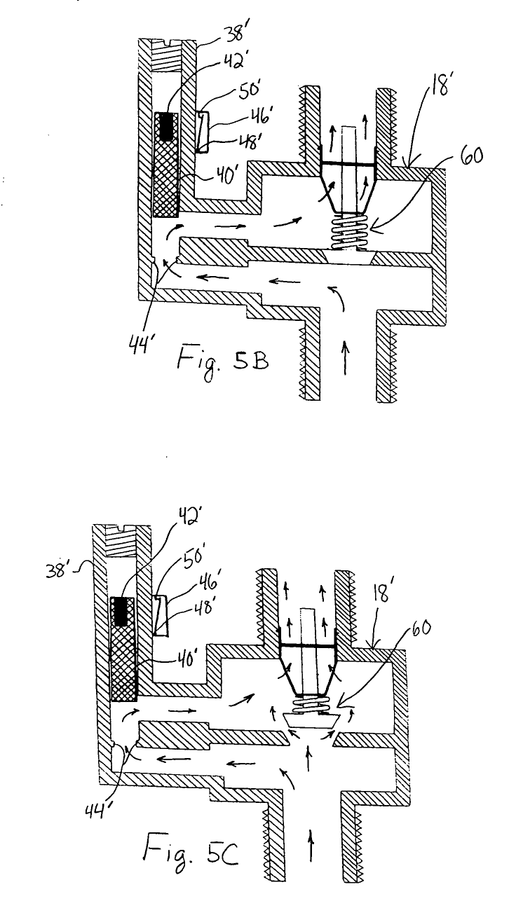

As shown in FIGS. 5A through 5C, the liquid flow detector 18′ may be an electro-mechanical flow detector including a housing 38′, a hydraulic piston 40′ having a specific gravity greater than the specific gravity of water and being linearly moveable within the housing 38′, a magnet 42′ at one end of the hydraulic piston 40′, a stop 44′ within the housing 38, and a reed switch 46′ mountable to the outside of the housing 38′. In this embodiment, the liquid flow detector 18′ may also include a flow restrictor assembly 60. The liquid flow detector 18′ may be electrically connected to the electronic alarm circuit 20 at the reed switch 46′ as shown in FIG. 4. The functioning of this embodiment of the liquid flow detector 18′ is illustrated by FIGS. 5A through 5C. In FIG. 5A, the flow detector 18′ is oriented vertically and there is no liquid, such as water, flowing through the flow detector. The piston 40′, having a specific gravity greater than water, rests against the stop 44′, in this case protrusions on an inner wall of the housing 38′. The magnet 42′ is thereby positioned below a pivot point 48′ of the reed switch 46′, and the reed switch 46′ rests a distance from an electric contact 50′. FIG. 5B illustrates low flow of liquid through the flow detector 18′. Water, represented by arrows, is flowing through the flow detector 18′. The flow of water pushes the piston 40′ linearly upwards. The flow restrictor assembly 60, however, remains in a closed position. The magnet 42′ is thereby positioned above the pivot point 48′ of the reed switch 46′, and the reed switch, itself magnetic, is drawn against the electric contact 50′. When the reed switch 46′ contacts the electric contact 50′, an electric circuit is closed, thereby providing an indication that there is flow through the flow detector 18′. FIG. 5C illustrates regular flow of liquid through the flow detector 18′. Water, represented by arrows, is flowing through the flow detector 18′. The flow of water pushes the piston 40′ linearly upwards. The flow restrictor assembly 60 is moved into an open position. The magnet 42′ is thereby positioned above the pivot point 48′ of the reed switch 46′, and the reed switch, itself magnetic, is drawn against the electric contact 50′.

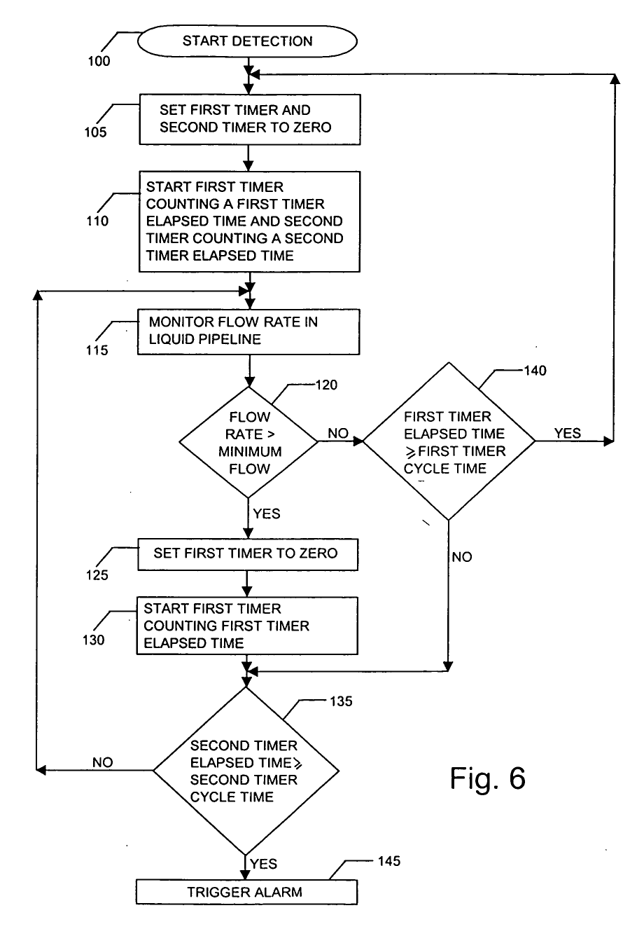

FIG. 6 is a flowchart illustrating the operations performed to detect a leak in a liquid pipeline in accordance with the present invention. Leak detection is initiated at block 100. This is achieved by installing a liquid flow detector 18, 18′ in a liquid pipeline and electrically connecting the flow detector to an electronic alarm circuit 20 having a first timer 22, a second timer 24, and an alarm 26 such as those detailed in FIGS. 1 through 5C. Further, electric power is supplied to the electronic alarm circuit 20 from a power source such as a battery 34. After leak detection is initiated, the first timer 22 and the second timer 24 are set to zero at block 105. Then at block 110, the first timer 22 is started to count a first timer elapsed time and the second timer is started to count a second timer elapsed time.

The flow rate in the liquid pipeline is monitored at block 115. If the flow rate in the pipeline is determined to be greater than a pipeline minimum flow at block 120, corresponding to a detection of flow in the pipeline, then the first timer 22 is set to zero at block 125 and begun counting a first timer elapsed time at block 130. A second timer query is then performed at block 135 described below. The pipeline minimum flow ideally is a value approaching zero gallons per hour, wherein a true physical state of no flow through the pipeline corresponds to a flow rate of exactly zero gallons per hour. The pipeline minimum flow, however, may be set at values such as 0.1 gallons per hour, 0.5 gallons per hour, or 1 gallon per hour, depending on the accuracy of the liquid flow detector 18, 18′ and the ability of the liquid flow detector to measure low flow rates such as those below 1 gallon per hour.

If the flow rate in the liquid pipeline is determined to not be greater than the pipeline minimum flow (i.e., less than or equal to the pipeline minimum flow) at block 120, then a first timer query is performed at block 140. If it is determined that the first timer elapsed time is equal to or greater than a first timer cycle time at block 140, then the leak detection operation is returned to its starting point. The first timer 22 and the second timer 24 are set to zero at block 105, the first timer is begun to count a first timer elapsed time and the second timer is begun to count a second timer elapsed time at block 110, and the flow rate in the liquid pipeline is monitored at block 115. The first timer cycle time is a short period of time such as an hour, but may be adjusted depending on the application of the leak alarm to values such as 5 minutes, 15 minutes, 30 minutes, 2 hours, etc. If it is determined that the first timer elapsed time is less than the first timer cycle time at block 140, then the leak detection operation is sent to the second timer query at block 135, described below. The purpose of the first timer query at block 140 is to establish whether there has been a short-term time period of no liquid flow in the pipeline at least as long as the first timer cycle time. If the period of no liquid flow occurs for a time period as long as the first timer cycle time, the operation concludes that there are no leaks in the liquid pipeline and the operation resets by returning back to block 105.

If at the second timer query of block 135 it is determined that the second timer elapsed time is less than the second timer cycle time, then the operation returns to block 115. The flow rate in the liquid pipeline is monitored at block 115 and a flow rate query is again performed at block 120. The second timer cycle time is a long period of time such as 72 hours, but may be adjusted depending upon the application of the leak alarm to values such as 12 hours, 24 hours, 48 hours, etc. It is only necessary that the second timer cycle time be a greater time than the first timer cycle time. If it is determined that the second timer elapsed time is equal to or greater than the second timer cycle time at block 135, then the alarm 26 is triggered at block 145. The purpose of the second timer query at block 135 is to establish whether there has been a long-term period of liquid flow in the pipeline, at intervals shorter than the first timer cycle time, for at least as long as the second timer cycle time. If the period of liquid flow occurs for a time period as long as the second timer cycle time, the operation concludes that there is a leak in the pipeline. The triggering of the alarm 26 communicates that a leak in the liquid pipeline has been detected. The leak may be repaired and the leak detection operation may be reinitiated at block 100.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

1. A leak alarm comprising:
a liquid flow detector; and
an electronic alarm circuit including a first timer, a second timer cooperable with and electrically connected to said first timer, and an alarm electrically connected to said second timer;
said first timer having a first timer cycle time and said second timer having a second timer cycle time, said first timer cycle time being shorter in time than said second timer cycle time;
said liquid flow detector being electrically connected to said electronic alarm circuit;
wherein said first timer resets itself to zero when said liquid flow detector senses a flow of liquid, said first timer resets both itself and said second timer to zero when said first timer reaches said first timer cycle time, and said second timer triggers said alarm when said second timer reaches said second timer cycle time.

2. The leak alarm of claim 1, wherein said first timer cycle time and said second timer cycle time are adjustable.

3. The leak alarm of claim 1, wherein said first timer cycle time is a time of less than one hour.

4. The leak alarm of claim 1, wherein said second timer cycle time is a time between 24 and 72 hours.

5. The leak alarm of claim 1, wherein said electronic alarm circuit further includes a reset button capable of simultaneously resetting said first and second timers to zero.

6. The leak alarm of claim 1, wherein said electronic alarm circuit further includes an LED that illuminates when said liquid flow detector senses a flow of liquid.

7. The leak alarm of claim 1, wherein said alarm is an audible alarm.

8. The leak alarm of claim 1, wherein said alarm is a radio frequency alert device.

9. The leak alarm of claim 1, wherein said alarm is a visual alarm.

10. The leak alarm of claim 1, wherein said liquid flow detector is an electro-mechanical flow detector including a housing, a hydraulic piston having a specific gravity greater than the specific gravity of water and being linearly moveable within said housing, a magnet at one end of said hydraulic piston, a stop within said housing, and a reed switch mountable to the outside of said housing, said liquid flow detector being electrically connected to said electronic alarm circuit at said reed switch.

11. The leak alarm of claim 1, wherein said liquid flow detector is capable of detecting flow rates of one gallon per hour and less.

12. A method of detecting a leak in a liquid pipeline comprising the steps of:
providing a liquid flow detector and an electronic alarm circuit having a first timer, a second timer, and an alarm;
initially setting both said first timer and said second timer to zero;
starting said first timer to count a first timer elapsed time and said second timer to count a second timer elapsed time;
monitoring a flow rate in the liquid pipeline with said liquid flow detector;
resetting said first timer to zero when the flow rate in the pipeline is greater than or equal to a pipeline minimum flow;
after the step of resetting said first timer to zero when the flow rate in the pipeline is greater than or equal to a pipeline minimum flow, starting said first timer to count said first timer elapsed time;
resetting both said first timer and said second timer to zero when the flow rate in the pipeline is below said pipeline minimum flow for a first timer elapsed time equaling a preset first timer cycle time;
after the step of resetting both said first timer and said second timer to zero when the flow rate in the pipeline is below said pipeline minimum flow for a first timer elapsed time equaling a preset first timer cycle time, starting said first timer to count said first timer elapsed time and said second timer to count said second timer elapsed time; and
triggering said alarm when said second timer elapsed time equals a preset second timer cycle time.

13. The method of claim 12, wherein said pipeline minimum flow is a value approaching zero gallons per hour.

14. The method of claim 12, wherein said first timer cycle time and said second timer cycle time are adjustable.

15. The method of claim 12, wherein said first timer cycle time is a time of less than one hour.

16. The method of claim 12, wherein said second timer cycle time is a time between 24 and 72 hours.
